(19) United States
(12) Patent Application Publication
(10) Pub. No.: US 2005/0044085 A1
(43) Pub. Date: Feb. 24, 2005

(54) Database generation method

(76) Inventor: Todres Yampel, Brooklyn, NY (US)

Correspondence Address: KAPLAN & GILMAN , L.L.P., 900 ROUTE 9 NORTH, WOODBRIDGE, NJ, 07095, US

(21) Appl. No.: 10/642,867

(22) Filed: Aug. 18, 2003

(51) Int. Cl. G06F 7/00

(52) U.S. Cl. 707/100

(57) ABSTRACT

A method of creating a database from input data is disclosed. The input data is acquired from another existing database or generated from the acquired data records from the another database. In particular, some of the input data is the original data from which the another database was created from. The input data in the input file is automatically filled into the fields in a sequence of input screens to generate the database.

### TECHNICAL FIELD OF THE INVENTION

The present invention relates to database migration, more particularly, to a method of efficiently generating a database from data records in another existing database such as a mainframe database.

### BACKGROUND OF THE INVENTION

Though computer technologies have been making giant strides for decades, mainframe systems are still shouldering the main responsibilities in many large entities such as banks, government agencies, etc. A major obstacle to eliminate the important role of a mainframe system is the huge database that has been built up over the decades in the mainframe system. Migration of data records from a mainframe system to an advanced computer system is always a difficult and costly task.

To avoid the difficulties of migration or transfer of data records from an older mainframe resident database to a database in a more modem computer system, or between different databases, a solution is conceived to create the new database from inputs. This solution, however, does not take advantage of the database existing in the mainframe, and is also impractical and costly if all the inputs have to be entered manually. Moreover, some inputs, such as some original inputs from which the mainframe database was generated, may not have been saved in any medium after being used in creating and deriving the mainframe database.

Therefore, there exists a need for a method of efficiently generating a database. In particular, it is desired that the method can make use of data records in another existing database while generating at least a part of the database to be generated that has values derived from the values in the another database, from values used to derive the another database, and from other information.

### SUMMARY OF THE INVENTION

The present invention teaches a novel method of generating at least part of a first database from a set of input data. In particular, at least some of the input data is acquired from a second database. Preferably, some input data, which does not exist in the second database, is generated from the data records existing in the second database. In a preferred embodiment, this non-existing input data includes original data from which the second database was created. Such original data is derived from the preexisting second database.

Preferably, an input file is created that comprises all the input data required for generating the part of the first database, which is generated from the input file by an automation process. In particular, the input data in the input file is automatically filled into relevant fields of a sequence of input screens generated by a software application for generating the part of the first database.

Preferably, each input screen is saved, such as in HTML format, after it is filled with the relevant input data. An error message is generated if an error is encountered while processing the filled screen, and one or more of the saved screens are retrieved to correct the problematic inputs that have caused the error.

### BRIEF EXPLANATION OF THE DRAWINGS

The features and advantages of the present invention will be clearer from the following detailed description of the preferred embodiments according to the present invention, with reference to the accompanying drawings, in which:

FIG. 1 is the schematic illustration of the method of the present invention;

FIG. 2 is an exemplary illustration of data inputs as well as data records in the mainframe databases;

FIG. 3 is a high-level illustration of the software application implementing the present invention.

### DETAILED DESCRIPTION OF THE INVENTION

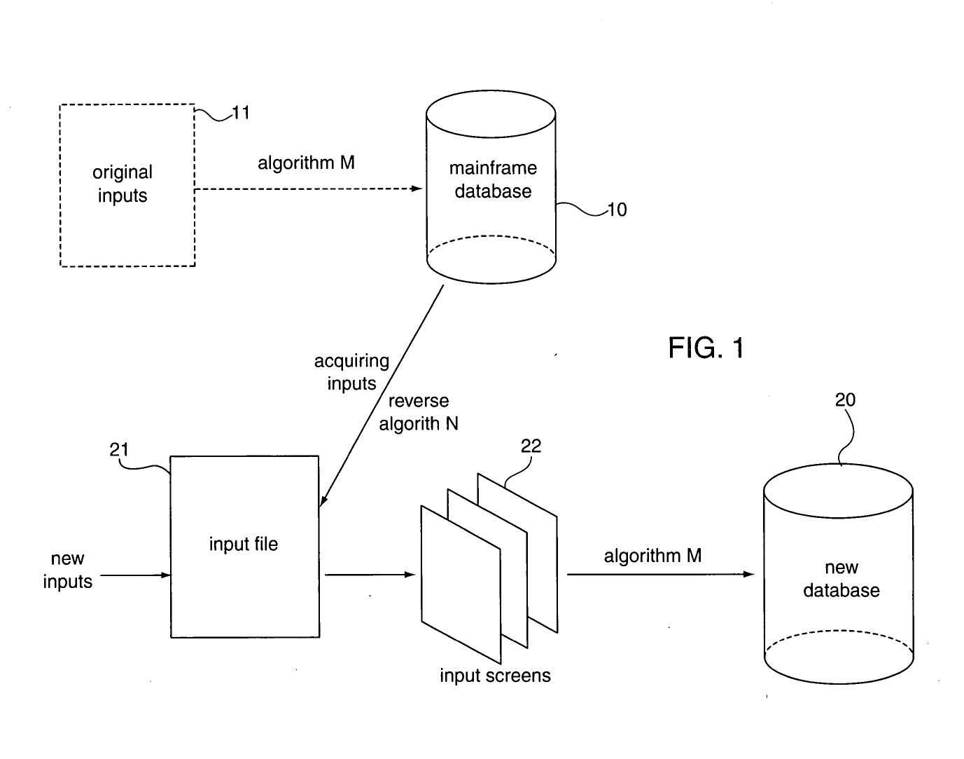

Reference is made to FIG. 1, in which a preferred embodiment of the present invention is schematically illustrated. As shown in FIG. 1, a new database 20 is to be generated from a set of input data which is preferably implemented as an input file 21. The input data in the input file 21 is filled into a sequence of screens 22. These screens 22 are typically provided by a software module which runs an Algorithm N to create the new database 20 from the input data filled in the screens 22, as will be explained in more detail below.

According to the present invention, at least some of the input data in the input file 21 is acquired from another database, which is typically a mainframe database 10. The mainframe database 10 was generated from original inputs 11 by an Algorithm M.

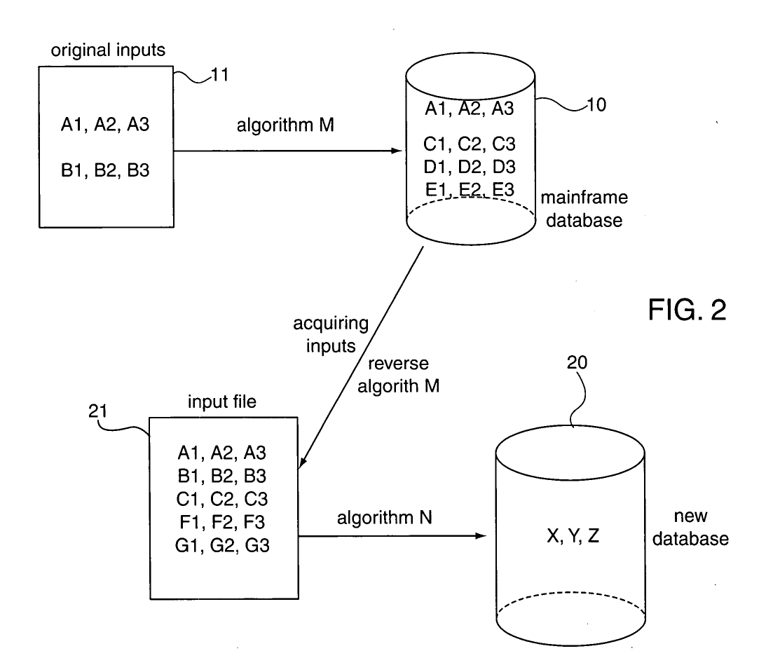

As shown in FIG. 2, input file 21 comprises a set of input data from which the database 20 is to be created. For the purpose of explanation of the concept of the present invention, the input data in the input file 21 is categorized into five groups A, B, C, F and G, which will be explained in more detail below. Similarly, the data records in the mainframe database 10 are also categorized into groups A, C, D and E, and the original data 11 is categorized into groups A and B.

Among the data records in the mainframe database 10, data records Al, A2, A3 of group A remain the same as those in the original inputs 11. This data may include some basic data entries such as client name, date, etc. Data records in groups C, D, E in the mainframe database 10 are generated from the Groups A and B in the original inputs 11 by running the Algorithm M, but do not exist in the original inputs 11. Thus, it is noted that original data B 1, B2, B3 in Group B in the original inputs 11 does not exist in the mainframe database 10.

In the process of generating the mainframe database 10, the original data in the original inputs 11 is often not saved in digital format before being deleted from the system. Sometimes even the original media, such as paper forms, which provided the original inputs 11, has been discarded or lost after they are used in generating the data records in the mainframe database 10. Therefore, the original inputs 11 may not exist in a digital format, or in any format, at the time that a new database 20 is to be generated. To this effect, the original inputs 11, as well as the arrow representing the Algorithm M, are shown in dashed lines.

In the input file 21, input data Al, A2, A3 in group A is the same as that in the original inputs 11. They can be simply acquired from the mainframe database 10 as they are data records of group A existing in the mainframe database 10. Similarly, input data C1, C2, C3 in group C can also be simply acquired from data records of group C existing in the mainframe database 10, which was generated from the groups A and B in the original inputs 11.

Input data B1, B2, B3 in group B in the input file 21, however, can not be simply acquired from the mainframe database 10 since it does not exist in the mainframe database 10. As explained above, the original inputs 11 may not be available in a digital format, thus input data B1, B2, B3 of group B has to be provided to the input file 21 manually, which is costly or even impractical when the number of the input data elements B1, B2, B3 of the group B is large.

According to the teaching of the present invention, there is no need to manually input the input data B1, B2, B3 of group B into the input file 21. Instead, input data B1, B2, B3 is generated from the existing data records in the mainframe database 10 which were generated from the original data B1, B2, B3 of group B in the original input 11. For example, suppose the data records D1, D2, D3 in group D in the mainframe data 10 was generated from the original data in groups A and B of the original inputs 11 by applying an Algorithm M. It is possible that the data of group B can be generated from the resultant data of group D by running a proper algorithm, which, for example, may be a reverse-engineering algorithm of the Algorithm M. In this way, there is no need to manually provide the data B1, B2, B3 in group B to the input file, regardless of whether the original inputs 11 are still available or not.

It is also possible that some of the data in the input file 21 does not exist in either the original inputs 11 or the existing records in the mainframe database 10. However, such data may have a specific relation with the existing records in the mainframe database 10. For example, if data F1, F2, F3 of group F in the input file 21 is not included in the original inputs 11 and does not exist in the mainframe database 10, it may still have a specific relationship and be derivable from data records D1, D2, D3 and E1, E2, E3 of groups D and E in the mainframe database 10. For instance, data in Group F may be an intermediate product in the process of generating data records of groups D and E from the original inputs 11 by applying the Algorithm M.

According to the present invention, like the data of group B, data F1, F2, F3 in group F can be generated by acquiring the data records D1, D2, D3 and El, E2, E3 of groups D and E from the mainframe database 10, and then applying a proper algorithm such as a reverse-engineering algorithm of the Algorithm M.

In addition to the data that is simply acquired from the mainframe database 10 or generated from the data records existing in the mainframe database 10, the input file may also include new input data, as represented by group G. The new input data G1, G2, G3 of group G may be data entries manually provided to the input file, or may be provided by other database or software applications.

The resultant data records X, Y, Z in the new database 20 are generated from the input data in the input file 21 by applying an Algorithm N. In particular, the data records X, Y, Z may include some or all of the data records in the mainframe database 10.

Therefore, instead of direct migration or transfer of the data records from the mainframe database 10 to the database 20 in a new computer system, the method of the present invention makes use of the data records existing in the mainframe database 10 to generate input data from which the new database 20 is created. This not only avoids the technical difficulties in database migration and transfer, but also facilitates the automation process in creating the new database since the manual entry of input data is minimized.

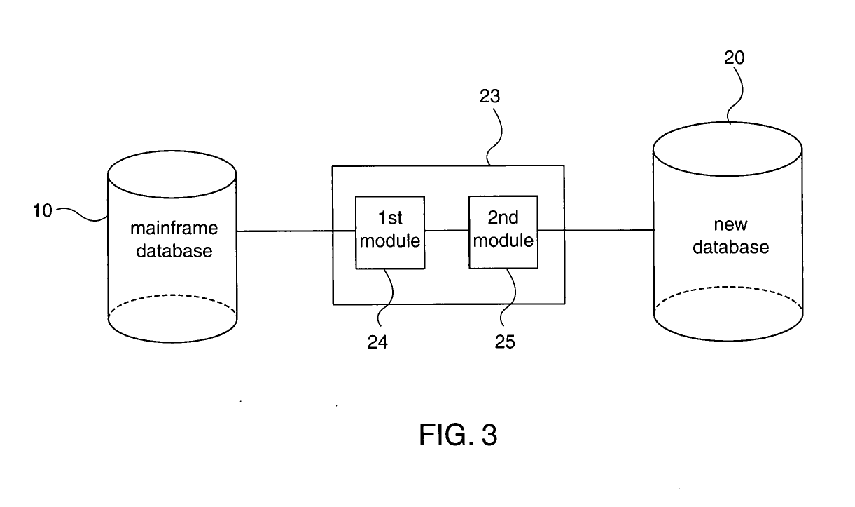

As shown in FIG. 1, the new database 20 is generated from input data in the input file 21, which, as explained above, may include input data acquired and/or generated from the existing data records in the mainframe database 10 as well as manually entered new inputs. According to the present invention, the input data in the input file 21 is provided to a sequence of input screens 22, each having a given screen ID and comprising plural fields to be filled with relevant input data. The screens 22 are created or provided by a software application or module (e.g., the module 25 in FIG. 3) for generating the database 20 from the input data by running an Algorithm N. Preferably, according to the fields in each screen 22, the required input data is automatically extracted from the input file 21 and is automatically filled into the respective fields in each screen 22.

Thus, the database 20 can be generated through an automation process. However, user interception is preferably allowed. For example, the screens 22 may be displayed to the user, so the user may intercept the automation process when necessary.

In a preferred embodiment, each screen 22 is saved after it is completed with input data. Advantageously, the filled screens 22 are saved in HTML format, with the filled input data shown in the respective fields. Each saved screen can be indexed with a new screen ID, which may, but need not, be related to its original ID. As an alternative, the filled screens can be saved in other formats, e.g., in text format.

According to the present invention, an error message is generated when an error is encountered while processing the filled screens 22 to generate the database 20. The error, for example, may be caused by an input data that does not meet the format required by relevant field of a screen. Preferably, the error message includes the IDs for the filled screens in which the error was encountered. Upon receiving the error message, the database generation process is paused or the user may intercept the automation process, and one or more of the saved screens 22, in which the error occurred, can be retrieved.

Preferably, the relevant field with the erroneous input data is highlighted in the retrieved screen or screens. Preferably, the user is allowed to correct the erroneous input data on the retrieved screen, and to resubmit the corrected screen to continue the database generation automation process. Advantageously, the same data input in the input file 21 is automatically corrected upon the correction of the retrieved screen 22.

As illustrated in FIG. 3, the present invention is preferably implemented in a software application 23 which comprises a first module 24 for generating the input file 21 and a second module 25 for generating the database 20 from the input data in the input file 21.

The first module 24 comprises means to acquire data from the mainframe database 10, to generate input data in the input file 21 from the acquired data records in the mainframe database 10, and to format the input data in the input file 21 to meet the requirements of the input screens 22. The first module 24 also allows manual data input.

The second module 25 comprises means to create and/or provide the input screens 22 to receive input data from the input file 21, and to generate the database 20 by running Algorithm N. Preferably, the second module 25 comprises means to automatically extract input data from the input file 21 and fill the same into the screens 22, and to save each screen 22 after it is completed with the input data from the input file 21. In addition, the second module 25 is capable of generating an error message when an error is encountered during the processing of the filled screens 22.

Though preferred embodiments have been described in detail above, numerous changes, amendments and adaptations are possible to a skilled person in the art without departing from the scope of the present invention.

For example, the database 20 may already exist, but is not a totally new database. Thus, the input data acquired from the database 10 may be used to create new records to be added to an existing database 20.

The input file 21 may also include input data extracted from other files. For example, data extracted from files sent from a credit card companies, phone companies, etc., can be included in the input file 21 to create and/or add records in a database 20, which may be a bank account database and may already exist.

Furthermore, even though a mainframe database 10 is described in the preferred embodiments, which usually is a different platform from the database 20, it can also be any non-mainframe database and may have the same platform as database 20. Thus, the present invention is also applicable in retaining valuable data from similar applications for different vendors.

It can be appreciated that, in the whole generating process, the input file 21 may be a temporary file or a spreadsheet, and the databases 10 and 20 can also be spreadsheets as well.

In addition, the two software modules 24 and 25 can also be implemented as two separate software applications, one for creating the input file 21, e.g., from the existing database 10, the other for generating the new database 20 from the input data in the input file 21. Preferably, the software application 23 or the two modules 24 and 25 can also work in an inverted way to extract data from database 20 so as to create data records for database 10. Also the application 23 can work in both directions simultaneously. For example, a computer running the application software 23 connects to the two different hosts (e.g., a mainframe system and a midrange computer), and the software application 23 may drives an application on the mainframe system to review account names in the mainframe database 10 and gather the information into a temporary file. At the end of the cycle, it starts to enter account application on the midrange and types in the data to create new accounts.

Therefore, the scope of the present invention is intended solely defined in the accompanying claims.

1. A method of generating at least a part of a database from a set of input data, comprising the steps of: acquiring at least some of said input data from another database, and generating said database from said first set of input data.

2. The method of claim 1 wherein said acquired input data comprises at least some data that does not exist in said another database, and said step of acquiring further comprises a step of generating said non-existing data from data existing in said another database.

3. The method of claim 2 wherein said non-existing data is some of original data from which said another database was generated.

4. The method of claim 3 wherein said step of generating said non-existing data comprises a reverse-engineering step to acquire said some original data from said existing data in said another database.

5. The method of claim 1 wherein said input data further comprises data that is not acquired from said another database.

6. The method of claim 1 wherein all of said input data is acquired from said another database.

7. The method of claim 1 wherein said step of generating comprises an automation step of generating said database from said.

8. The method of claim 7 wherein said automation step comprises a step of automatically filling said input data into relevant fields in a sequence of input screens created by an application for generating said database.

9. The method of claim 8 further comprising a step of creating an input file which comprises said set of input data, and said automation step comprising automatically providing said input data from said input file to said input screens.

10. The method of claim 1 further comprising a step of processing said some data acquired from said another database to meet a format requirement on said set of input data.

11. The method of claim 8 further comprises a step of saving each of said input screens after it is filled with said input data.

12. The method of claim 1 1 wherein said filled input screens are saved in HTML format with said filled data shown in said relevant fields.

13. The method of claim 11 wherein said filled input screens are saved in text format.

14. The method of claim 11 further comprising a step of generating an error messages when an error is encountered while generating said database from said input data.

15. The method of claim 14 further comprising a step of retrieving a saved screen which caused the error.

16. The method of claim 15 further comprising a step of displaying said retrieved screen, with problematic relevant fields highlighted.

17. A method of generating at least a part of a second database from a first database which was generated from a first set of input data, comprises:
acquiring a second set of input data from said first database;
generating said second database at least partly from said second set of input data.

18. The method of claim 17 wherein at least some of said second set of input data does not exist in said first database.

19. The method of claim 18 wherein said first set of input data comprises at least some of said non-existing data.

20. The method of claim 19 wherein said step of acquiring said second set of input data from said first database comprises a step to acquire said non-existing data that was included in said first set of input data.

21. The method of claim 20 wherein said step to acquire said non-existing data is a reverse-engineering step that generates, from data existing in said first database, said non-existing data that was included in said first set of input data.

22. A method of generating a new database, comprising steps of acquiring a set of data from an existing another database and using said acquired data as at least part of input for generating said new database.

23. The method of claim 22 wherein said step of acquiring comprises a step of using data existing in said another database to acquire data that does not exist in said another database.

24. The method of claim 23 wherein said non-existing data are original inputs from which said another database was generated.

25. The method of claim 24 wherein said step of acquiring comprises a reverse-engineering step to acquire said original inputs that do not exist in said another database.

26. A method of generating a database from a set of inputs, comprising steps of:
filling said inputs into a sequence of input screens provided by an application for generating said database;
saving each of said input screens together with said filled inputs; and
when an error is encountered, generating an error message and retrieving one or more of said saved input screens from which said error was resulted.

27. The method of claim 26 wherein said error is caused by an erroneous input, and said method further comprises highlighting a data field of said erroneous input on said retrieved screens.

28. The method of claim 27 further comprising steps of correcting said erroneous input in said retrieved screens and resubmitting said corrected input screens to said application.

29. The method of claim 26 further comprising a step of providing an input file which comprises all inputs required by said application.

30. The method of claim 29 wherein said step of filling said input into said input screens is implemented by an automation software application.

31. The method of claim 30 wherein said step of filling comprises a step of, in accordance to input fields provided in said input screens, extracting inputs from said input file and filling said extracted inputs into said input fields.

32. The method of claim 31 further comprising a step of displaying said retrieved one or more input screens from which said error was resulted.

33. The method of claim 32 further comprises highlighting one or more data fields of erroneous inputs on said retrieved screens that have caused the error.

34. The method of claim 33 further comprising steps of correcting said erroneous inputs in said highlighted fields and resubmitting said corrected input screens to said application.

35. The method of claim 34 wherein said step of correcting erroneous inputs on said retrieved screens automatically corrects relevant inputs in said input file.

36. A software application for generating a database, comprising:
a first module for generating an input file comprising a set of input data;
a second module for generating said database from said set of input data; and
means for extracting said set of input data from said input file and providing said extracted input data to said second module.

37. The application of claim 36 wherein said first module comprises means for acquiring data from another database.

38. The application of claim 37 wherein said first module further comprises means for generating at least some of said input data from said acquired data.

39. The application of claim 38 wherein said some input data generated from said acquired data is original data from which said another database was generated.

40. The application of claim 39 wherein said original data does not exist in said another database.

41. The application of claim 40 wherein said first module comprises a reverse-engineering algorithm for generating said original data from said data acquired from said another database.

42. The application of claim 36 wherein said second module comprises means for generating input screens each having one or more fields into which said extracted input data is filled.

43. The application of claim 42 wherein said second module further comprises means for saving each screen after it is filled with said extracted input data.

44. The application of claim 43 wherein said second module further comprises means for generating an error message if an error is encountered.

45. The application of claim 44 wherein said second module further comprises means for retrieving one or more of said saved screens which comprises an erroneous data which caused said error.

46. The application of claim 45 wherein said second module further comprises means for displaying said retrieved screens to a user.

47. The application of claim 46 wherein said displaying means further comprises means for allowing said user to correct said erroneous data in said retrieved screens, and resubmitting said retrieved screens after correction.
